(19) United States
(12) Patent Application Publication
(10) Pub. No.: US 2012/0130509 A1
(43) Pub. Date: May 24, 2012

(54) Method for Adjusting a Measuring Device

(75) Inventors: Matthias Altendorf, Lorrach (DE); Peter Klöfer, Steinen (DE); Dietmar Spanke, Steinen (DE)

(73) Assignee: Endress + Hauser GmbH + Co. KG, Maulburg (DE)

(21) Appl. No.: 13/297,553

(22) Filed: Nov. 16, 2011

(30) Foreign Application Priority Data
Nov. 19, 2010 (DE) DE102010044182.1

(51) Int. Cl. G05B 13/04

(52) U.S. Cl. 700/30

(57) ABSTRACT

A method and a system for adjusting a measuring device. The measuring device, determines the physical or chemical process variable based on measurement data; an analytical tool, ascertains the analytical data from the measurement data; a database, in which data sets with analytical data for different process conditions and associated parameter sets for adjusting the measuring device are stored, or in which a plurality of models with associated calculational specifications are stored, which produce the analytical data; and a calculation/control unit, which compares the ascertained analytical data with the stored analytical data, ascertains that data set of the stored analytical data, which has maximum agreement with the ascertained analytical data and adjusts the measuring device corresponding to the associated parameter set.

The invention relates to a method for adjusting a measuring device for determining or monitoring a physical or chemical process variable of a medium in a container as a function of the process- and/or device conditions reigning at the measuring location as a function of a predetermined application.

In automation technology, especially in process automation technology, often measuring devices are applied, which serve for registering and/or influencing process variables. Serving for registering process variables are sensors, such as, for example, fill level measuring devices, flow measuring devices, pressure- and temperature measuring devices, pH-redox potential measuring devices, conductivity measuring devices, etc., which register the corresponding process variables, fill level, flow, pressure, temperature, pH-value, and conductivity, respectively. Often, instead of the terminology, measuring device, also the terminology, field device, is used. Serving for influencing process variables are actuators, such as, for example, valves or pumps, via which the flow of a liquid in a section of pipeline, or the fill level in a container, can be changed. Referred to as field devices are, in principle, all devices, which are applied near to the process and which deliver, or process, process relevant information. Thus, in connection with the invention, are under the terminology, field devices, fall especially also remote I/Os, radio adapters, or, generally, devices, which are arranged at the field level. A large number of such field devices are available from the firm, Endress+Hauser.

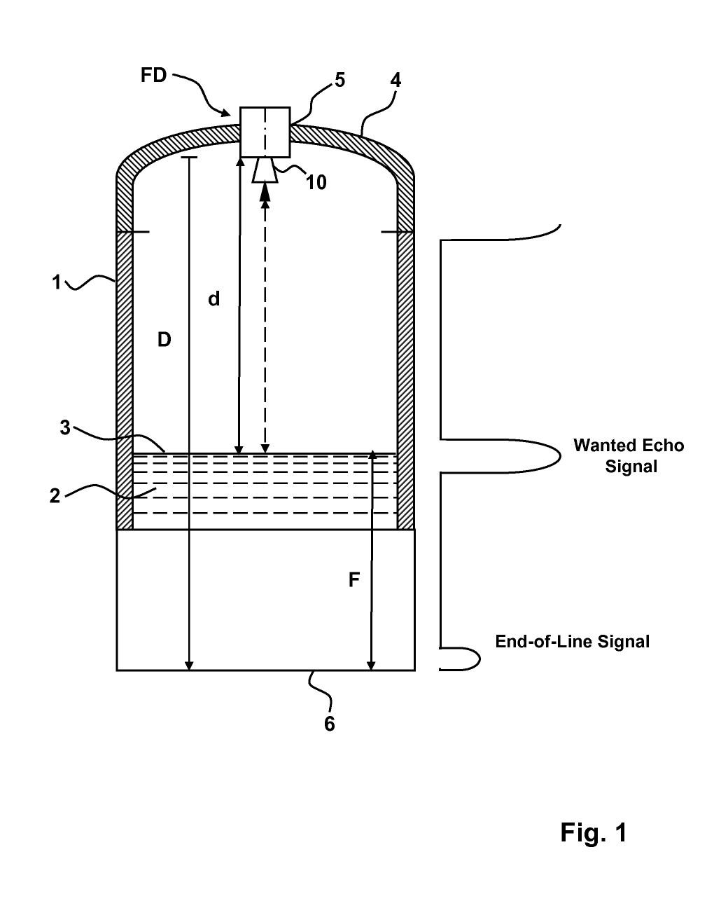

In the following, a fill-level measuring device, which works according to a travel-time method, will be described in greater detail. Reference is to FIG. 1. Travel-time methods utilize the physical principle, according to which travel distance equals the product of travel time and propagation velocity. In the case of fill level measurement, travel distance corresponds to twice the distance d between the antenna 10 secured in an opening 5 in the container lid 4 and the surface 3 of the fill substance 2. The wanted echo signal, thus the signal reflected on the surface 3 of the fill substance 2, and its travel time, are determined based on the so-called echo function, or the digitized envelope curve, wherein the envelope curve shows the amplitudes of the echo signals as a function of the separation, ‘antenna 10 to surface 3 of the fill substance 2’. The fill level F itself results then from the difference between the known distance of the antenna 10 from the floor of the container 1 and the distance, as determined by the measuring, of the surface 3 of the fill substance 2 from the antenna 10.

All known methods can be applied, which enable relatively short distances to be determined by means of reflected measuring signals. If the measurement signals are microwaves, then both pulse radar as well as also frequency modulation continuous wave radar (FMCW-radar) can be used. Microwave measuring devices, which use pulse radar, are available from the assignee, for example, under the mark, ‘MICROPILOT’. A device type, which works with ultrasonic signals, is available from the assignee, for example, under the mark, ‘PROSONIC’.

In the case of pulse radar, periodically, broadband microwave pulses of a transmitting/receiving unit are either freely radiated or else guided along a waveguide. The microwave pulses are largely reflected on the surface of the fill substance and, after a distance dependent, travel time, received in the transmitting/receiving unit. The amplitudes of the pulses ascertained as a function of time form the so-called echo curve. Each value of the echo function corresponds to the amplitude of an echo signal reflected at a certain distance from the antenna.

In the case of the FMCW method, a continuous microwave is transmitted, which is periodically, linearly, frequency modulated, for example, according to a sawtooth function. The frequency of the received echo signal has, consequently, relative to the instantaneous frequency, which the transmission signal has, at the point in time of the receipt, a frequency difference, which depends on the travel time of the echo signal. The frequency difference between transmission signal and received signal, as won by mixing both signals and evaluating the Fourier spectrum of the mixed signal, corresponds, thus, to the distance of the reflecting surface from the antenna. Additionally, the amplitudes of the spectral lines of the frequency spectrum won by Fourier transformation correspond to the echo amplitudes. This Fourier spectrum represents the echo function in this case.

At installation, for the purpose of assuring optimal measuring performance, the measuring device must be suitably adjusted. This adjusting, in the case of which especially filter adjustments are involve, occurs as a function of the process- and/or device conditions reigning at the measuring location. These conditions depend basically on the application of the measuring device. In terms of adjustments, for example, noise fractions of the signal, or signal components coming from a stirrer (see e.g. DE 100 24 353 A1) or other disturbing factors, are masked out. For this, in given cases, special technical knowledge is required, so that the adjusting can usually only be done by correspondingly trained technicians.

An object of the invention is to provide a method, with which the adjusting of a measuring device can be implemented in simple manner. Special knowledge should not be required.

The object is achieved according to a first embodiment by a method comprising steps as follows:
Measurement data, which represent a physical, biological or chemical process variable at the measuring location, are ascertained;
based on the ascertained measurement data, via an extraction- and/or reduction process, analytical data are won, which represent features for the application, in which the measuring device is applied;
in a database, a plurality of data sets with analytical data are stored, wherein the data sets reflect analytical data, which have been ascertained, directly or by simulation, as a function of different process- and/or device conditions in different applications, wherein there is associated with each data set a parameter set, which reflects an optimized adjusting of the measuring device as a function of the defined process- and/or device conditions;
the ascertained analytical data are compared with the stored or simulated analytical data and that data set is selected from the database, in the case of which the stored or simulated analytical data have maximum agreement with the ascertained analytical data; and
the adjusting of the measuring device occurs corresponding to the parameter set associated with the stored analytical data having maximum agreement with the ascertained analytical data.

In a second alternative, the object is achieved by a method comprising steps as follows:
Measurement data, which represent a physical, biological or chemical process variable at the measuring location, are ascertained;
based on the ascertained measurement data, analytical data are won via an extraction- and/or reduction process;
in a database, a plurality of models are stored, which produce analytical data, wherein the analytical data have been ascertained or simulated based on different process- and/or device conditions, wherein there is associated with each model a calculational recipe for determining a parameter set, which reflects an optimized adjusting of the measuring device as a function of the defined process- and/or device conditions;
the ascertained analytical data are compared with the stored analytical data generated from the stored or simulated models;
that data set is selected from the database, in the case of which the generated analytical data have maximum agreement with the ascertained analytical data; and
the adjusting of the measuring device occurs corresponding to the parameter set associated with the stored model generating analytical data having maximum agreement with the ascertained analytical data. The database is preferably provided by the device manufacturer.

These two embodiments of the solution of the invention bring the considerable advantage that, with reference to adjusting a newly mounted measuring device, adjustments can be used, which have already proved themselves in identical, or at least similar, applications under identical, or similar, process- and/or device conditions at the measuring location. Thus, adjusting can be performed in simple manner.

A advantageous embodiment of the method of the invention provides that the parameter set is won from the analytical data by means of a calculational recipe. This calculational recipe can, in the case of a microwave- or ultrasound-measuring device, for example, ascertain the positions of the maxima of the echo curve. This example will be subsequently described in greater detail.

Furthermore, it is provided, that the measurement data are determined as a function of time, distance or a process variable.

A preferred embodiment of the method of the invention provides that a travel time, fill-level measuring device is used as measuring device, wherein, as measurement data, the echo curve is used, which is the curve of amplitude of a measurement signal as a function of time or as a function of fill level in the container or flow in a line. Alternatively, an option is to use the intermediate frequency signal as measurement data. Of course, the method of the invention is also suitable for a flow measuring device, which works, for example, with ultrasonic signals and the travel time principle. In such case, the flow profile curve can be used as measurement data. In general be the method can, however, be used in the case of any measuring device type and is not limited to travel time measurements for fill level determination, which is described in the following in greater detail by way of example. To be mentioned is that the use the method of the invention becomes more beneficial, the greater the complexity of the measurement data to be evaluated, or the greater the complexity of the measuring signals. Besides the echo curve, the evaluation of frequency spectra for analytical purposes is explicitly named in this connection.

Preferably, are in the case of an echo curve as analytical data, the positions of the maxima or of the corresponding intermediate signals are ascertained. Alternatively or supplementally, the position of the end of line signal is ascertained, which is the part of the measurement signal, which is reflected on the floor of the container.

Advantageously, the selected parameter set is displayed or transmitted to a user. Alternatively, the corresponding parameter set is first transmitted to the measuring device for the purpose of adjusting the measuring device, when the user has confirmed the selected parameter set.

An apparatus suitable for performing the method of the invention comprises: A measuring device, which determined the physical or chemical process variable based on measurement data; an analytical tool, which ascertains the analytical data from the measurement data; a database, in which the data sets with analytical data for different process conditions and the associated parameter sets for adjusting the measuring device can be stored or simulated, or in which a plurality of models with associated calculational specifications are stored, which produce the analytical data. Furthermore, a calculation/control unit is provided, which compares the ascertained analytical data with the stored analytical data, ascertains the data set of the stored analytical data, which has the maximum agreement with the ascertained analytical data and adjusts the measuring device corresponding to the associated parameter set.

An advantageous further development of the apparatus of the invention provides that the measuring device is integrated into a bus system with a superordinated control system. The database can, in such case, depending on the resources, which are present, be associated with the measuring device, the analytical tool or the control system.

In an advantageous embodiment of the apparatus of the invention a handheld servicing device with a listener function is provided, which monitors the measurement data on the bus system or at the measuring device and transmits such to the analytical tool.

Preferably, the handheld servicing device is a cell phone, which receives the measurement data via radio, ascertains the analytical data based on the measurement data and accesses the database for the purpose of comparing the ascertained analytical data with the stored analytical data.

An alternative embodiment of the apparatus of the invention provides that a web server is provided, which is accessible via Internet or intranet and via which the database with the stored analytical data or with the analytical data and parameter sets calculated based on the models is available online. This opens the opportunity to have always highly current information available.

The invention will now be explained in greater detail based on the appended drawing, the figures of which show as follows:

FIG. 1 a fill-level measuring device working according to the travel-time method;

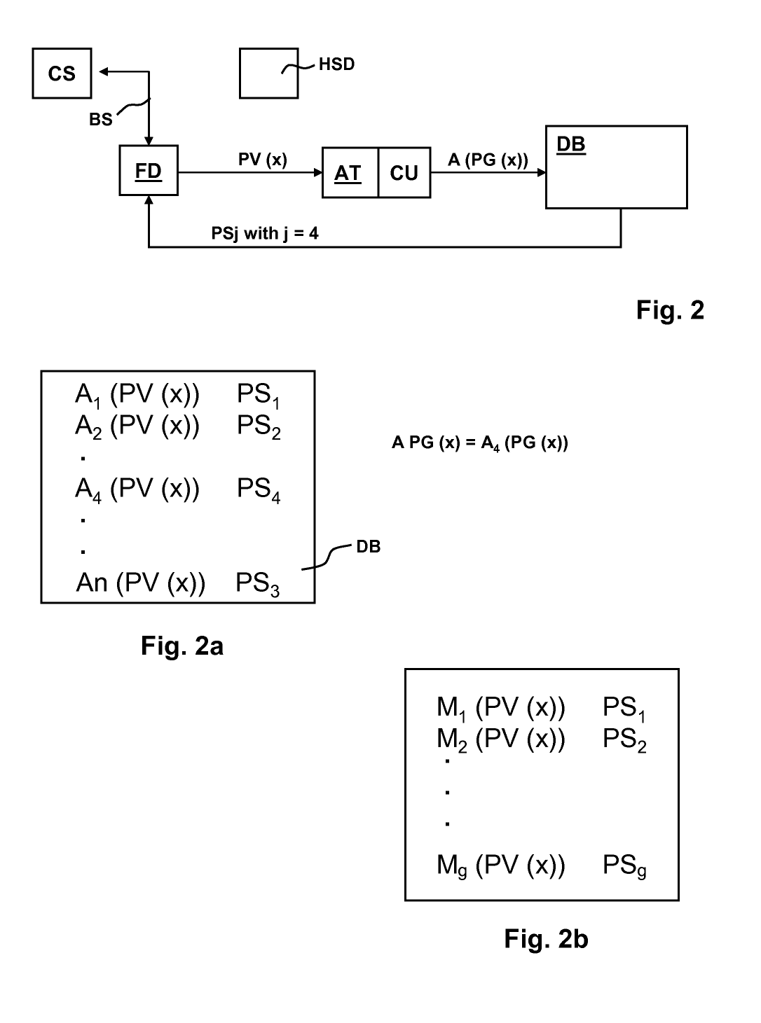

FIG. 2 a schematic representation of an embodiment of the apparatus of the invention;

FIG. 2a a schematic representation of the content of the database, in which the stored or via model, just in time calculated, data sets are stored with the associated parameter settings;

FIG. 2b a schematic representation of the content of the database, in which the stored models are stored with the associated parameter settings;

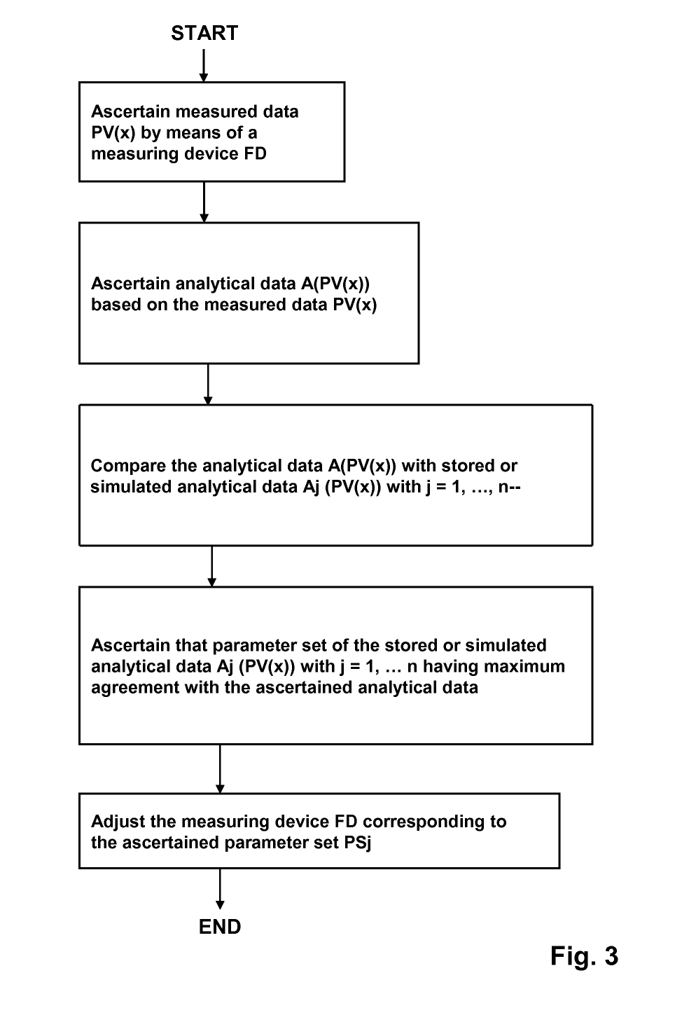

FIG. 3 a flow diagram illustrating the method of the invention;

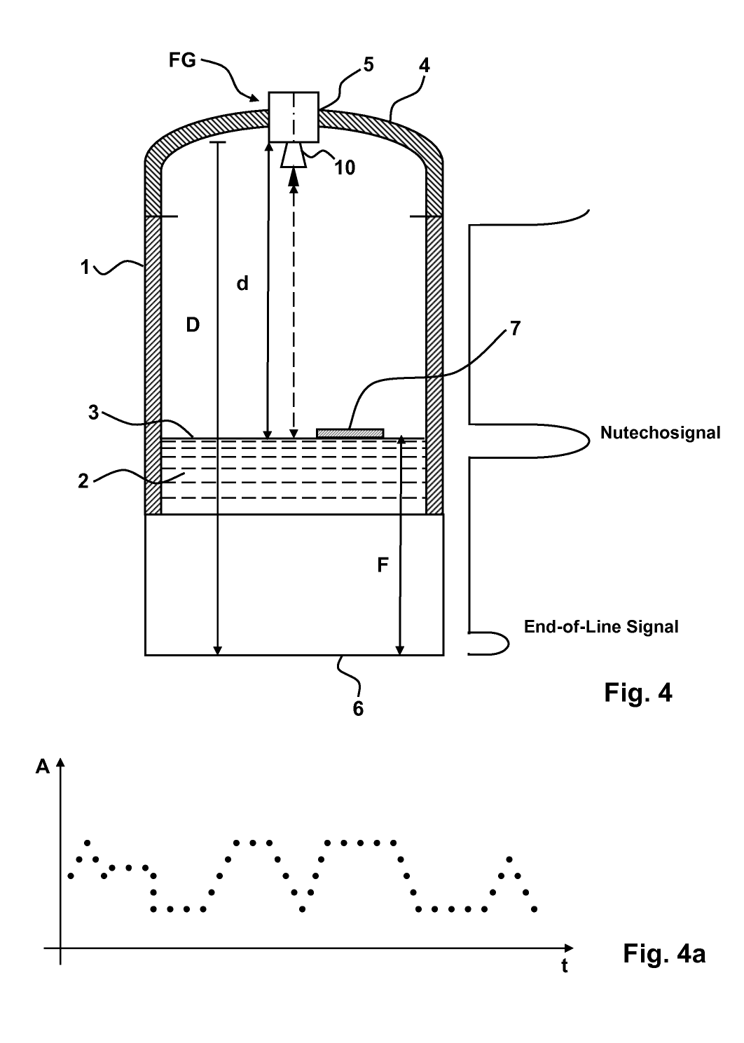

FIG. 4 a concrete embodiment for optimizing measuring in a container with foam.

FIG. 1 shows a fill-level measuring device FD working according to the travel-time method. As already mentioned above, the invention is applicable in the case of any field devices FD determining any physical, chemical or biological, process variables. Examples have already been cited above.

Quite generally stated, the measuring device FD delivers measurement data PV(x), wherein the variable x can be time t, distance d or an any other process variable PV*. Shown in FIG. 1 beside the application “radar device for fill level measurement of a defined medium 2 in a defined container 1” is the so-called echo curve, which shows the amplitudes of the measuring signals as a function of time t or—in equivalent manner—as a function of the distance d. Shown especially are the wanted echo signal, thus the signal portion of the measurement signal, which was reflected on the surface 3 of the fill substance 2, and the so-called end of line signal, which represents the signal portion of the measurement signal, which was reflected on the floor 6 of the container 1.

On the basis of the ascertained measurement data PV(x), analytical data A(PV(x)) are won in the analytical tool AT via a known extraction- and/or reduction process. The analytical data A(PV(x)) are characteristic for the particular application, in which the radar measuring device FD is applied. For example, in the case of the shown echo curve, or of the shown intermediate signal, the positions of the maxima are ascertained as analytical data A(PV(x)). Furthermore, for generating the analytical data A(PV(x)), for example, the position of the end of line signal is ascertained. These analytical data A(PV(x)) represent the measurement data PV(x) in the respective application in a compressed and/or reduced shape. In DE 100 24 959 A1, a method for compressed data transmission is disclosed. This known method can be applied in connection with the invention.

According to the invention, in the database DB, a plurality of data sets with analytical data Aj(PV(x) with j=1, 2, . . . , n) are stored. These data sets with analytical data Aj(PV(x) with j=1, 2, . . . , n) were earlier ascertained, directly or by simulation, as a function of different process- and/or device conditions in different applications. The content of a corresponding database DB is shown schematically in FIG. 2a. FIG. 2b shows the alternative, wherein the database DB stores, instead of earlier ascertained analytical data, a plurality of models Mk(PV(x) with k=1, 2, . . . , g). Via these models Mk(PV(x) with k=1, 2, . . . , g), the analytical data Ak(PV(x)) are produced by a computing unit CU. Especially, then the optimal analytical data Ak(PV(x)) can be found via a dynamic fitting (Fit) of the model parameters.

According to the invention, associated with each data set with analytical data Aj(PV(x) with j=1, 2, . . . , n) present in the database DB or produced via a simulation is a parameter set PSj, which represents an optimized adjusting of the measuring device FD as a function of the defined process- and/or device conditions in the respective application. The ascertained analytical data A(PV(x)) are subsequently compared with the stored or simulated analytical data Aj(PV(x) with j=1, 2, . . . , n), and that data set with analytical data Ak(PV(x)) is selected from the database DB, in the case of which the stored or via a model ascertained analytical data Aj(PV(x) with j=1, 2, . . . , n) have a maximum agreement with the ascertained analytical data A(PV(x)). In the illustrated case, involved is the data set A4(P(x)). As a result, the parameter set PS4 is used for adjusting the measuring device FD. This parameter set PS4, or, generally stated, the parameter sets PSj include, especially, filter settings, via which measuring performance of the measuring device FD can be optimized by, for example, masking out reflections on disturbing elements, or noise signals.

The database DB can be associated both with the measuring device FD as well as also with the analytical tool AT. If the measuring device FD is connected via a bus system BS, e.g. via a fieldbus, the Internet and/or an intranet, with a superordinated control system CS, then the database DB can also be integrated into the control system CS.

Seen as especially advantageous is when the database DB with the stored analytical data Aj(PV(x)) and parameter sets PSj is integrated into a web server, so that, at any time, highly current data contents are available online.

Preferably, the measurement data PVj(x) are monitored on the bus system BS or at the measuring device FD by means of a handheld servicing device HSD with a listener function and transmitted to the analytical tool AT. The handheld servicing device HSD can be an iPod or a cell phone, which receives the measurement data PV(x) via radio, ascertains the analytical data Aj(PV(x)) based on the measurement data PVj(x) and transmits to the database DB for the purpose of comparing the ascertained analytical data A(PV(x)) with the stored analytical data Aj(PV(x)) or analytical data calculated via a corresponding model. Of course, the forwarding of the measuring- and analytical data can also occur by hardwire. The analytical tool AT with the corresponding computing unit CU can be located at any suitable position of the system of the invention.

FIG. 3 shows a flow diagram, which illustrates the individual method steps of the method of the invention as already earlier described.

FIG. 4 shows a fill-level measuring device FD installed in a container 1 and working according to the travel time principle. The process conditions reigning at the measuring location are such that foam islands 7 are floating on the medium 2. The foam islands attenuate the signal reflected from the surface of the fill substance 3. In the case of a device not fitted to this process condition, a short-term echo loss can be experienced, due to the strong amplitude fluctuations, which can lead to reduced availability of data or even to a faulty measurement.

According to the invention, a method is applied to ascertain PV(t) data in the form of the amplitude of the echo signal versus time; this data is presented in FIG. 4a. Via a reduction algorithm, for example, the standard deviation A(PV(t)) of the amplitude is determined over the considered time range. On the basis of the standard deviation an optimal adjusting of the envelope curve statistics is deduced via comparison with stored standard deviations Aj(PV(t)). By the optimal adjusting of the envelope curve statistics, a short term echo loss or a faulty measurement can be avoided.

1-13. (canceled)

14. A method for adjusting a field device in automation technology, wherein the field device is applied preferably for determining or monitoring a physical or chemical process variable of a medium in a container as a function of process- and/or device conditions reigning at the measuring location as a function of a predetermined application, comprising the steps of:
ascertaining measurement data, which represent the physical, biological or chemical process variable at the measuring location;
based on the ascertained measurement data, via an extraction- and/or reduction process, analytical data are won, which represent features for the application, in which the field device, or the measuring device, is applied;
storing in a database, a plurality of data sets with analytical data, wherein the data sets reflect analytical data, which have been ascertained, directly or by simulation, as a function of different process- and/or device conditions in different applications, wherein there is associated with each data set with analytical data a parameter set, which reflects an optimized adjusting of the field device, or measuring device, as a function of the defined process- and/or device conditions;
comparing the ascertained analytical data with the stored or simulated analytical data and wherein that data set is selected from the database, in the case of which the stored analytical data have maximum agreement with the ascertained analytical data; and
the adjusting of the field device, or of the measuring device, occurs corresponding to the parameter set associated with the stored analytical data having maximum agreement with the ascertained analytical data.

15. A method for adjusting a field device of automation technology, wherein the field device preferably is applied for determining or monitoring a physical or chemical process variable of a medium in a container as a function of process- and/or device conditions reigning at the measuring location as a function of a predetermined application, comprising the steps of:
ascertaining measurement data, which represent the physical, biological or chemical process variable at the measuring location;
based on the ascertained measurement data, analytical data are won via an extraction- and/or reduction process;
storing in a database, a plurality of models, which produce analytical data, wherein the analytical data have been ascertained or simulated based on different process- and/or device conditions, wherein there is associated with each model a calculational recipe for determining a parameter set, which reflects an optimized adjusting of the field device, or of the measuring device as a function of the defined process- and/or device conditions;
comparing the ascertained analytical data with the stored analytical data generated from the stored models and wherein that data set is selected from the database, in the case of which the generated analytical data have maximum agreement with the ascertained analytical data; and
the adjusting of the field device, or of the measuring device, occurs corresponding to the parameter set associated with the stored model having maximum agreement with the ascertained analytical data.

16. The method as claimed in claim 15, wherein:
the parameter set is won from the analytical data by means of a calculational recipe.

17. The method as claimed in claim 14, wherein:
the measurement data are determined as a function of time, distance or a process variable.

18. The method as claimed in claim 14, wherein:
used as measuring device is a travel time, fill level- or flow measuring device; and
used as measurement data is the echo curve or the flow profile curve, which is the curve of amplitude of a measurement signal as a function of time or as a function of fill level in the container or the flow in a line, or wherein used as measurement data is the intermediate frequency signal.

19. The method as claimed in claim 17, wherein:
as analytical data the positions of the maxima of the echo curve or of the intermediate signal are ascertained; and/or
as analytical data the position of the end of-line signal is ascertained, which reflects that part of the measurement signal, which is reflected on the floor of the container.

20. The method as claimed in claim 14, wherein:
the selected parameter set is displayed or transmitted to a user and wherein, once the user has confirmed the selected parameter set, such is transmitted to the measuring device for the purpose of adjusting the measuring device.

21. An apparatus for adjusting a measuring device, wherein the measuring device determines the physical or chemical process variable based on measurement data, the apparatus comprises:
an analytical tool, which ascertained analytical data from the measurement data;
a database, in which data sets with analytical data for different process conditions and associated parameter sets for adjusting the measuring device are stored or in which a plurality of models are stored with associated calculational specifications, which produce the analytical data; and
a calculation/control unit, which compares the ascertained analytical data with the stored analytical data, ascertains that data set of the stored analytical data, which has maximum agreement with the ascertained analytical data and adjusts said measuring device corresponding to the associated parameter set.

22. The apparatus as claimed in claim 21, wherein:
said measuring device is integrated into a bus system having a superordinated control system.

23. The apparatus as claimed in claim 21, wherein:
the database is associated with said measuring device, the analytical tool or the control system.

24. The apparatus as claimed in claim 21, wherein:
further comprising:
a handheld servicing device with a listener function, which monitors measurement data on the bus system or at the measuring device and transmits such to the analytical tool.

25. The apparatus as claimed in claim 24, wherein:
said handheld servicing device is a cell phone, which receives the measurement data via radio, ascertains the analytical data based on the measurement data and transmits the analytical data to the database for the purpose of comparing the ascertained analytical data with the stored analytical data.

26. The apparatus as claimed in claim 21, further comprising:
a web server, which is accessible via Internet or intranet and via which the database with the stored analytical data and parameter sets is available online.
